(19) United States
(12) Patent Application Publication
(10) Pub. No.: US 2023/0113171 A1
(43) Pub. Date: Apr. 13, 2023

(54) AUTOMATED ORCHESTRATION OF SKILLS FOR DIGITAL AGENTS

(71) Applicant: INTERNATIONAL BUSINESS MACHINE CORPORATION, Armonk, NY (US)

(72) Inventors: Kushal Mukherjee, New Delhi (IN); Rakesh Rameshrao Pimplikar, Bangalore (IN); Ramasuri Narayanam, Andhra Pradesh (IN); Gyana Ranjan Parija, Gurgaon (IN); Nidhish M. Pathak, Bangalore (IN); Nidhi Sagar, Bangalore (IN); Anish Jain, Ghaziabad (IN)

(21) Appl. No.: 17/450,343

(22) Filed: Oct. 8, 2021

(51) Int. Cl. G06N 5/02; G06N 5/04; G06F 40/40; G06F 9/50

(52) U.S. Cl. CPC G06N 5/022; G06N 5/043; G06F 40/40; G06F 9/5038

(57) ABSTRACT

A system, method, and computer program product for implementing automated digital agent communication and control is provided. The method includes retrieving from a digital agent, a query associated with knowledge based control process. Digital knowledge elements, associated digital skills, and a sequence of control operations are received to obtain a response to the query. A first possible set of knowledge of a set of digital knowledge elements, skills, and an associated sequence of operation are selected and the first possible set of knowledge, skills, and associated sequence of operation are transmitted to the digital agent. A sequence of skills are executed with respect to digital knowledge elements and components and a hardware interface device is enabled to interact with and control various devices for enabling operational functionality associated with devices. Knowledge based fabric code associated with future instances of enabling the hardware interface device is updated.

### BACKGROUND

The present invention relates generally to a method for automating digital agent communication and in particular to a method and associated system for improving software technology associated with retrieving a query, selecting and executing associated digital skills, and enabling a hardware interface device to interact with devices for enabling operational functionality associated providing a set of knowledge, skills, and an associated sequence of operation.

### SUMMARY

A first aspect of the invention provides a hardware device comprising a processor coupled to a computer-readable memory unit, the memory unit comprising instructions that when executed by the processor implements an automated digital agent communication and control method comprising: retrieving, by the processor from a first digital agent via a software/hardware interface, a query associated with knowledge based control process; receiving, by the processor from the first digital agent, a set of digital knowledge elements, associated digital skills, and a sequence of control operations and associated code to obtain a response to the query; selecting, by the processor based on the set of digital knowledge elements, the associated digital skills, and the sequence of control operations and associated code, a first possible set of knowledge of the set of digital knowledge elements, skills of the associated digital skills, and an associated sequence of operation of the sequence of control operations; transmitting, by the processor to the first digital agent, the first possible set of knowledge, the skills, and the associated sequence of operation; executing, by the processor via the first agent in response to the transmitting, a sequence of skills of the skills with respect to digital knowledge elements and components associated with the associated sequence of operation; enabling, by the processor, a hardware interface device to interact with and control various devices for enabling operational functionality associated with devices for providing the first possible set of knowledge, the skills, and the associated sequence of operation; and updating, by the processor via the first digital agent, knowledge based fabric code associated with future instances of the enabling the hardware interface device.

A second aspect of the invention provides a automated digital agent communication and control method comprising: retrieving, by a processor of a hardware device from a first digital agent via a software/hardware interface, a query associated with knowledge based control process; receiving, by the processor from the first digital agent, a set of digital knowledge elements, associated digital skills, and a sequence of control operations and associated code to obtain a response to the query; selecting, by the processor based on the set of digital knowledge elements, the associated digital skills, and the sequence of control operations and associated code, a first possible set of knowledge of the set of digital knowledge elements, skills of the associated digital skills, and an associated sequence of operation of the sequence of control operations; transmitting, by the processor to the first digital agent, the first possible set of knowledge, the skills, and the associated sequence of operation; executing, by the processor via the first agent in response to the transmitting, a sequence of skills of the skills with respect to digital knowledge elements and components associated with the associated sequence of operation; enabling, by the processor, a hardware interface device to interact with and control various devices for enabling operational functionality associated with devices for providing the first possible set of knowledge, the skills, and the associated sequence of operation; and updating, by the processor via the first digital agent, knowledge based fabric code associated with future instances of the enabling the hardware interface device.

A third aspect of the invention provides an automated digital agent communication and control method comprising: retrieving, by a processor of a hardware device from a first digital agent via a software/hardware interface, a query associated with knowledge based control process; receiving, by the processor from the first digital agent, a set of digital knowledge elements, associated digital skills, and a sequence of control operations and associated code to obtain a response to the query; selecting, by the processor based on the set of digital knowledge elements, the associated digital skills, and the sequence of control operations and associated code, a first possible set of knowledge of the set of digital knowledge elements, skills of the associated digital skills, and an associated sequence of operation of the sequence of control operations; transmitting, by the processor to the first digital agent, the first possible set of knowledge, the skills, and the associated sequence of operation; executing, by the processor via the first agent in response to the transmitting, a sequence of skills of the skills with respect to digital knowledge elements and components associated with the associated sequence of operation; enabling, by the processor, a hardware interface device to interact with and control various devices for enabling operational functionality associated with devices for providing the first possible set of knowledge, the skills, and the associated sequence of operation; and updating, by the processor via the first digital agent, knowledge based fabric code associated with future instances of the enabling the hardware interface device.

The present invention advantageously provides a simple method and associated system capable of automating digital agent communication.

### BRIEF DESCRIPTION OF THE DRAWINGS

FIG. 1 illustrates a system for improving software technology associated with retrieving a query, selecting and executing associated digital skills, and enabling a hardware interface device to interact with devices for enabling operational functionality associated providing a set of knowledge, skills, and an associated sequence of operation, in accordance with embodiments of the present invention.

FIG. 2 illustrates an algorithm detailing a process flow enabled by the system of FIG. 1 for improving software technology associated with retrieving a query, selecting and executing associated digital skills, and enabling a hardware interface device to interact with devices for enabling operational functionality associated providing a set of knowledge, skills, and an associated sequence of operation, in accordance with embodiments of the present invention.

FIG. 3 illustrates an internal structural view of the software/hardware of FIG. 1, in accordance with embodiments of the present invention.

FIG. 4 illustrates a system for executing a task associated with a query, in accordance with embodiments of the present invention.

FIG. 5 illustrates an algorithm detailing a process flow enabled by the system of FIG. 4 for executing a query using a machine identified by a knowledge fabric, in accordance with embodiments of the present invention.

FIG. 6 illustrates an algorithm detailing a process flow enabled by the system of FIG. 4 for executing multiple sub-queries via collaboration among agents of a machine, in accordance with embodiments of the present invention.

FIG. 7 illustrates an algorithm detailing a process flow enabled by the system of FIG. 4 for generating a machine via orchestration of agents and skills using bottom-up approach, in accordance with embodiments of the present invention.

FIG. 8 illustrates an algorithm detailing a process flow enabled by the system of FIG. 4 for generating a machine via orchestration of agents and skills using top-down approach, in accordance with embodiments of the present invention.

FIG. 9 illustrates a process for enabling digital agents to collaboratively maintain a meta knowledge network, in accordance with embodiments of the present invention.

FIG. 10 illustrates a first alternative process for enabling digital agents to collaboratively maintain a meta knowledge network, in accordance with embodiments of the present invention.

FIG. 11 illustrates a second alternative process for enabling digital agents to collaboratively maintain a meta knowledge network, in accordance with embodiments of the present invention.

FIG. 12 illustrates a knowledge fabric comprising edges in a CKM, in accordance with embodiments of the present invention.

FIG. 13 illustrates an alternative knowledge fabric comprising edges in a CKM, in accordance with embodiments of the present invention.

FIG. 14 illustrates a computer system used by the system of FIG. 1 for improving software technology associated with retrieving a query, selecting and executing associated digital skills, and enabling a hardware interface device to interact with devices for enabling operational functionality associated providing a set of knowledge, skills, and an associated sequence of operation, in accordance with embodiments of the present invention.

FIG. 15 illustrates a cloud computing environment, in accordance with embodiments of the present invention.

FIG. 16 illustrates a set of functional abstraction layers provided by cloud computing environment, in accordance with embodiments of the present invention.

### DETAILED DESCRIPTION

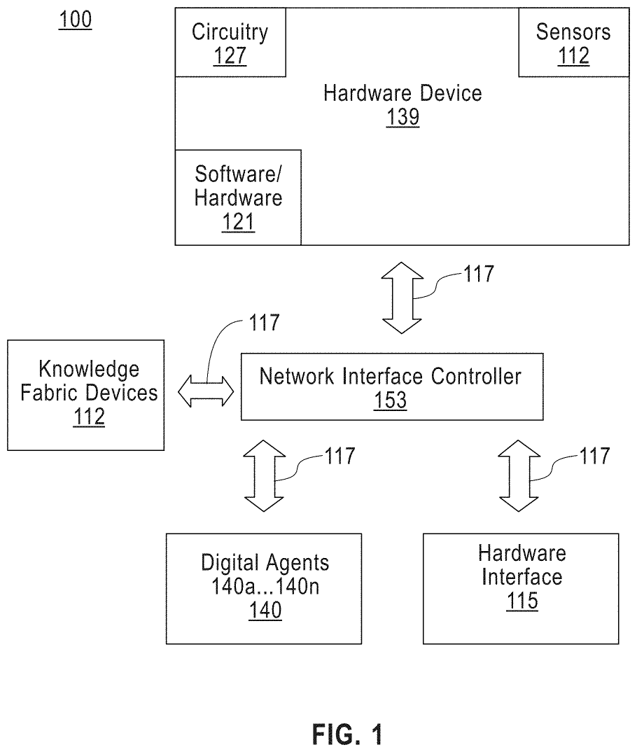

FIG. 1 illustrates a system 100 for improving software technology associated with retrieving a query, selecting and executing associated digital skills, and enabling a hardware interface device to interact with devices for enabling operational functionality associated providing a set of knowledge, skills, and an associated sequence of operation, in accordance with embodiments of the present invention. Typical industrial processes defined by human to machine and machine to machine collaboration may necessitate execution of agent-based models and models for collaboration and competition between agents for enterprise process transformation. Likewise, typical industrial processes may struggle to determine how digital agents may autonomously sequence together knowledge and skills of current agents or shared by additional agents to efficiently perform previously observed tasks or sub-tasks or new (never observed previously) tasks to respond to control requests from interface users or agents. Therefore, system 100 is configured to enable a knowledge fabric (KF) component for completely identifying digital skills and knowledge used and generated in the past and currently available for use. Likewise, system 100 is configured to enable an orchestrator software/hardware agent based on artificial intelligence (AI) methods to orchestrate and/or compose sequences of digital knowledge and skills and associated digital agents and assistants required to respond to a query.

System 100 enables a process for orchestration and/or composition for digital agent(s) such that system 100 provides the following functionality:

System 100 enables a process for leveraging a knowledge marketplace (KM) associated with a knowledge fabric comprising digital agents configured to store, fetch, harvest, and trade knowledge elements, skills, process flows, and agent machine declarations that enable agents to autonomously orchestrate/compose skills and to perform control tasks. A knowledge fabric comprises a graph for relating knowledge elements: G:K×K×R→[0,1] where K comprises a set of digital knowledge elements, R comprises a set of relations between digital knowledge elements (e.g., correlation, replaceability, used by, etc.). A knowledge fabric enables discovery of new knowledge and improved network search capabilities. Likewise, a knowledge fabric enables agents to infer a utility of knowledge elements based on relations encoded within edges device. Agents may not be able to detect all content in a knowledge marketplace as they may be enabled to only detect a subset of content dependent on a (software/hardware) computing power. A knowledge fabric is generated by enabling digital agents to submit knowledge to the KM and providing additional graph edges to cause knowledge elements to be discoverable. Additional digital r agents may determine a validity of an edge device within a collaborative version. Likewise, various versions of a meta knowledge network may be simultaneously persisted.

System 100 enables a knowledge fabric to capture: digital agent roles/hierarchy and delegation structure; objective key results (OKR) value chain elements; digital skills and knowledge taxonomy; evolving knowledge lineage within a multi-agent setting; an agent skills knowledge repertoire; and additional digital concepts/controls obtained from expert sources.

System 100 is configured to use a labeled property graph for capturing metadata regarding knowledge elements and skills (nodes) and a relationship between knowledge elements and skills (edges). An ontology may be enabled for nodes and edges in addition to past transaction data and agent reputation. Likewise, system 100 may leverage one or more quality metrics for generating a data and reputation/proficiency score for digital skills. Digital knowledge may be accepted into a marketplace and stitched it into a network fabric by accepting edges to the network fabric. The digital knowledge may be applied to user agents.

System 100 is further configured to leverage an orchestration and/or composition system (comprising a digital agent) that retrieves a query or task description from an agent interfacing with a human user and explores a knowledge fabric to provide a sequence(s) of digital skills/knowledge operation to perform a control task. An orchestrator may use a knowledge fabric to obtain novel pipelines/sequences that have not been observed by using graph analytics and reasoning. System 100 may be further enabled for ranking a set of possible sequences based on a frequency of prior application of a whole or part of a sequence.

System 100 of FIG. 1 includes a hardware device 139, digital agents 140a . . . 140n, hardware interface 115, and knowledge fabric devices 112, a hardware interface 115, and a network interface controller interconnected through a network 117. Hardware device 139 comprises sensors 112, circuitry 127, and software/hardware 121. Hardware interface may comprise any type of hardware based interface including, inter alia, a text interface, a voice activated interface, a virtual reality interface, etc. Knowledge fabric devices 112 may comprise devices for providing digital knowledge elements, associated digital skills, a sequence of control operations and associated code, etc. Hardware device 139, digital agents 140a . . . 140n, hardware interface 115, and knowledge fabric devices 112 each may comprise an embedded device(s). An embedded device is defined herein as a dedicated device or computer comprising a combination of computer hardware and software (fixed in capability or programmable) specifically designed for executing a specialized function. Programmable embedded computers or devices may comprise specialized programming interfaces. In one embodiment, hardware device 139, digital agents 140a . . . 140n, hardware interface 115, and knowledge fabric devices 112 may each comprise a specialized hardware device comprising specialized (non-generic) hardware and circuitry (i.e., specialized discrete non-generic analog, digital, and logic-based circuitry) for (independently or in combination) executing a process described with respect to FIGS. 1-6. The specialized discrete non-generic analog, digital, and logic-based circuitry (e.g., sensors 112, circuitry/logic 127, software/hardware 121, etc.) may include proprietary specially designed components (e.g., a specialized integrated circuit, such as for example an Application Specific Integrated Circuit (ASIC) designed for only implementing an automated process for improving software technology associated with retrieving a query, selecting and executing associated digital skills, and enabling a hardware interface device to interact with devices for enabling operational functionality associated providing a set of knowledge, skills, and an associated sequence of operation. Sensors 112 may include any type of internal or external sensors including, inter alia, GPS sensors, Bluetooth beaconing sensors, cellular telephone detection sensors, Wi-Fi positioning detection sensors, triangulation detection sensors, activity tracking sensors, a temperature sensor, an ultrasonic sensor, an optical sensor, a video retrieval device, humidity sensors, voltage sensors, network traffic sensors, etc. Network 117 may include any type of network including, inter alia, a local area network, (LAN), a wide area network (WAN), the Internet, a wireless network, etc.

System 100 is enabled to execute a knowledge (hardware/software) fabric comprising knowledge (e.g., csv files, ml models. Etc.) and skills (e.g., APIs, py files, etc.). Therefore, an orchestration system is configured to enable hardware and software pipelines comprising knowledge and skills.

A dynamic composition of microservices may be enabled based on a predetermined description computer language such that the microservices are configured to analyze matching input and output for services to determine compositions/plans. System 100 leverages reasoning algorithms with respect to a knowledge fabric to identify potential hardware and software pipelines. The enabled dynamic composition of microservices allow for obtaining hardware and software pipelines to enable the knowledge fabric to constantly capture past operations associated with skills associated with knowledge retrieved via digital agents for enabling improved pipeline recommendations for multiple hardware and software pipelines. Likewise, the enabled dynamic composition of microservices enables a transfer of knowledge within a multi-agent setting such that digital agents may leverage hardware and software pipelines that have been used by others.

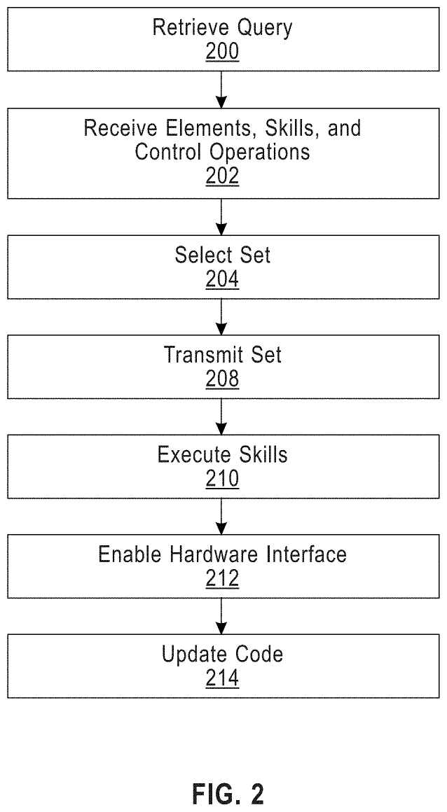

FIG. 2 illustrates an algorithm detailing a process flow enabled by system 100 of FIG. 1 for improving software technology associated with retrieving a query, selecting and executing associated digital skills, and enabling a hardware interface device to interact with devices for enabling operational functionality associated providing a set of knowledge, skills, and an associated sequence of operation, in accordance with embodiments of the present invention. Each of the steps in the algorithm of FIG. 2 may be enabled and executed in any order by a computer processor(s) executing computer code. Additionally, each of the steps in the algorithm of FIG. 2 may be enabled and executed in combination by hardware device 139, digital agents 140a . . . 140n, hardware interface 115, and knowledge fabric devices 112 of FIG. 1. In step 200, a query associated with a knowledge based control process is retrieved from a digital agent via a software/hardware interface. In step 202, a set of digital knowledge elements, associated digital skills, and a sequence of control operations and associated code are received (from the digital agent) a to obtain a response to the query. In step 204, a first possible set of knowledge, skills, and an associated sequence of control operations are selected from results of step 202. The selection process may include executing an additional query associated with a social hardware and software machine with respect to the knowledge based control process. The selection process may alternatively include executing (via multiple digital agents) multiple sub-queries associated with a social hardware and software machine with respect to the knowledge based control process. As a further alternative, the selection process may include generating (via multiple digital agents) a social hardware and software machine via execution of bottom-up approach software code and/or top-down approach software code.

In step 208, the first possible set of knowledge, skills, and associated sequence of control operations are transmitted to the digital agent. In step 210, a sequence of skills are executed with respect to digital knowledge elements and components associated with the associated sequence of operation. In step 212, a hardware interface device is enabled to interact with and control various devices for enabling operational functionality associated with devices for providing the first possible set of knowledge, skills, and associated sequence of operation. The enabling process may be performed with respect to results of the additional query and/or the multiple sub-queries of step 204. Likewise, the enabling process may be performed in response to execution of the bottom-up approach software code or top-down approach software code of step 204. The software/hardware interface may include, inter alia, a text interface, a voice activated interface, an artificial intelligence (AI) interface, etc.

In step 214, knowledge based fabric code associated with future instances of enabling said hardware interface device is updated. Updating the knowledge based fabric code may include adding (to the knowledge based fabric code) results of the query with respect to digital tasks executed by multiple digital agents or enabling orchestration code for selecting optimal sequence code.

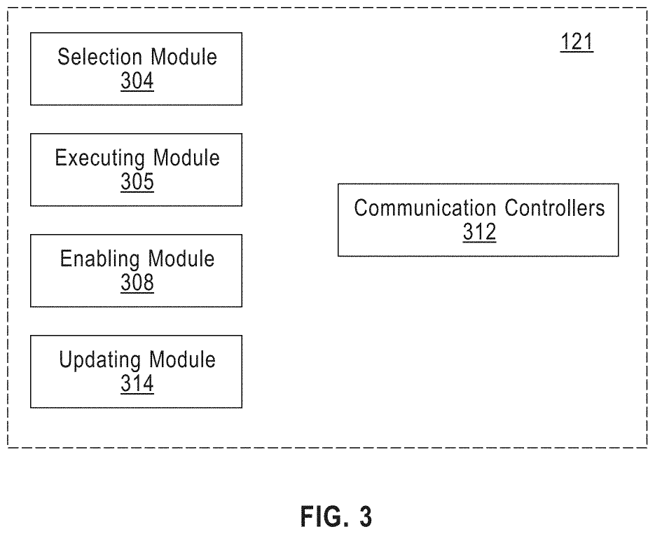

FIG. 3 illustrates an internal structural view of software/hardware 121 of FIG. 1, in accordance with embodiments of the present invention. Software/hardware 121 includes a selection module 304, an executing module 305, an enabling module 308, an updating module 314, and communication controllers 312. Selection module 304 comprises specialized hardware and software for controlling all functions related to the selection steps of FIG. 2. Executing module 305 comprises specialized hardware and software for controlling all functionality related to the executing steps described with respect to the algorithm of FIG. 2. Enabling module 308 comprises specialized hardware and software for controlling all functions related to the interface enabling steps of FIG. 2. Updating module 314 comprises specialized hardware and software for controlling all functions related to the software/code updating steps of the algorithm of FIG. 2. Communication controllers 312 are enabled for controlling all communications between selection module 304, executing module 305, enabling module 308, and updating module 314.

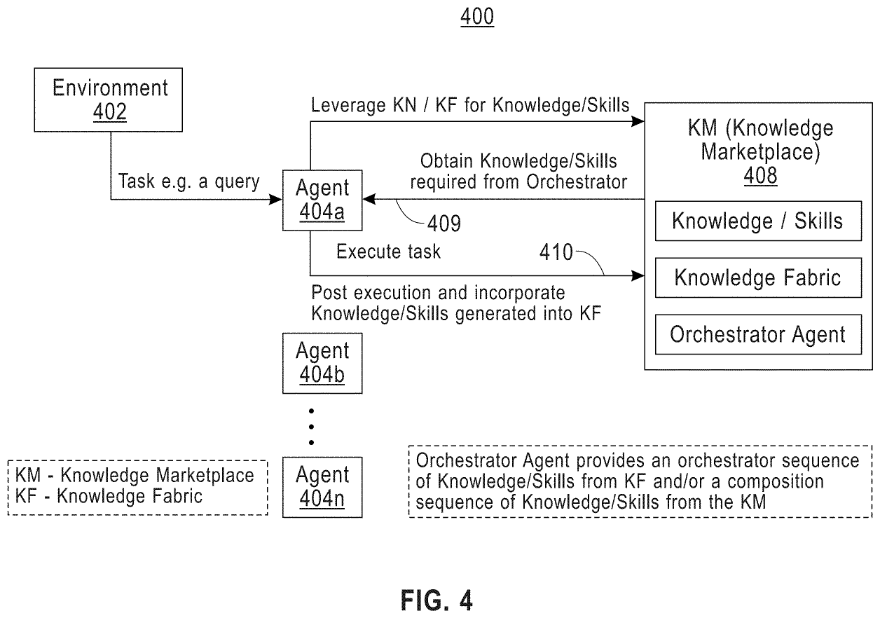

FIG. 4 illustrates a system 400 for executing a task associated with a query, in accordance with embodiments of the present invention. System 400 enables a single (digital) agent (of agents 404a . . . 404n) interacting with an environment 402 (e.g., a hardware/software environment) such that AI processes (e.g., optimization and sequence-modeling) are used by an orchestrator component for composition/orchestration. System 400 comprises multiple (digital) agents 404a . . . 404n interacting with a knowledge marketplace (KM) 408 comprising digital knowledge and skills 408a, a knowledge fabric 408b, and an orchestrator agent 408c associated with environment 402. Knowledge fabric 408b may comprise caching mechanisms and alternate data structures. Likewise, system 400 comprises machines comprising of a digital assistant enabling agents 404a . . . 404n executing digital task. The machines are configured to coordinating the execution of agents 404a . . . 404n remaining hidden from environment 402. System enables the following process for executing tasks:

The process is initiated when an agent (of agents 404a . . . 404n) receives a query from a user or digital assistant. The query may be a natural language query (e.g., via a chat interface/voice, etc.) or a prespecified structure/schema query (e.g., Json). Subsequently, the agent requests that orchestrator agent 408c within KM 408 provide a set of digital knowledge elements, skills, and a sequence of operation to obtain a response to the query. (e.g., as a rest API). In response, orchestrator agent 408c uses digital content of knowledge fabric 408b to obtain a possible set of knowledge/skills and an associated sequence of operation. Processes for obtaining a possible set of knowledge/skills and an associated sequence of operation may include:

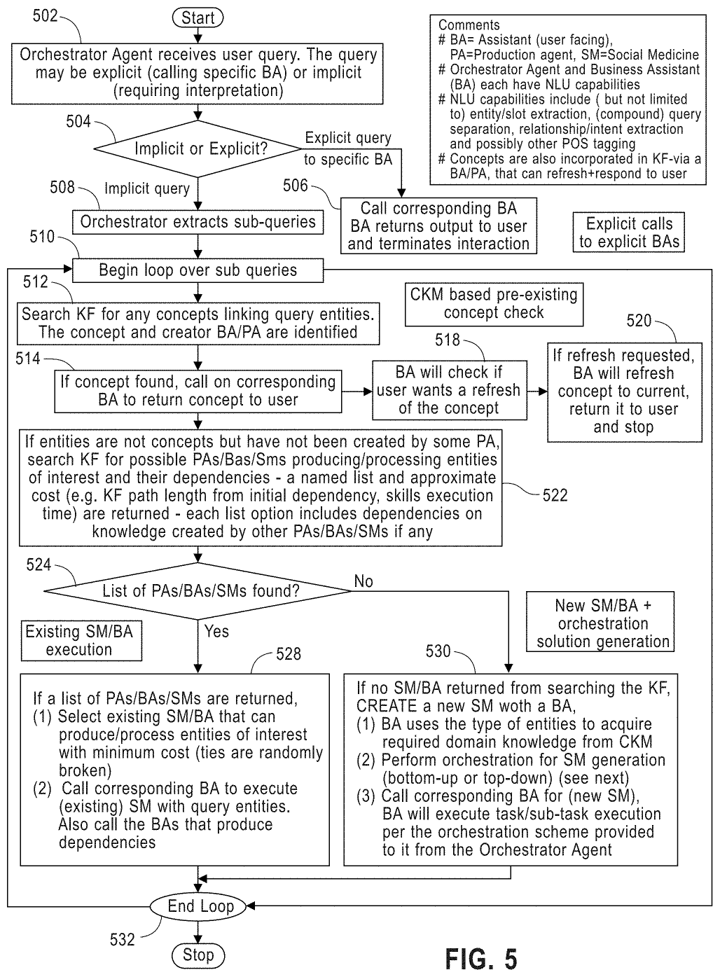

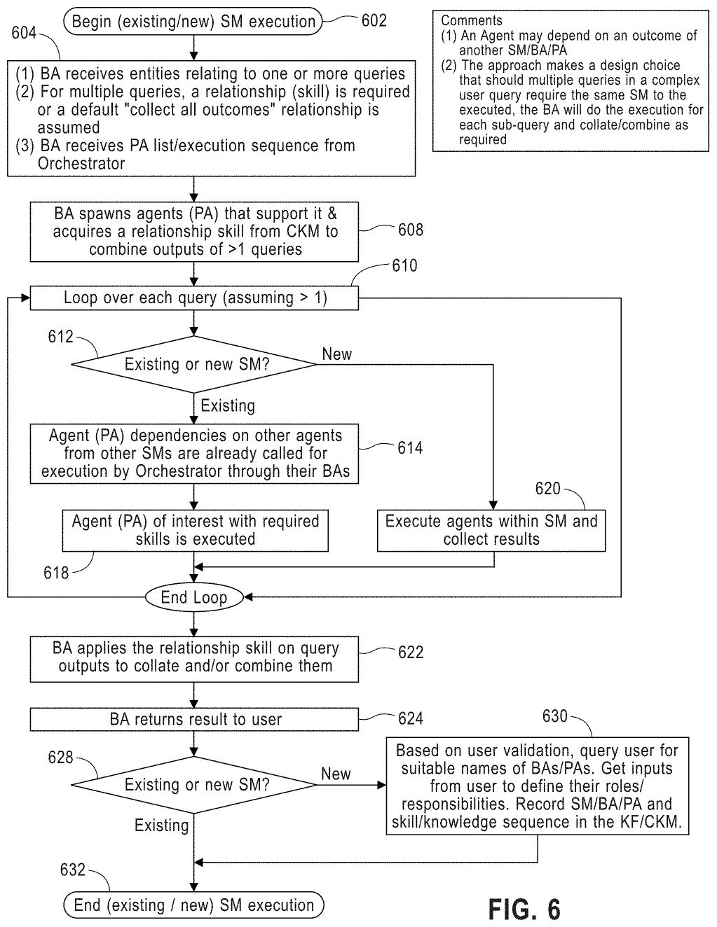

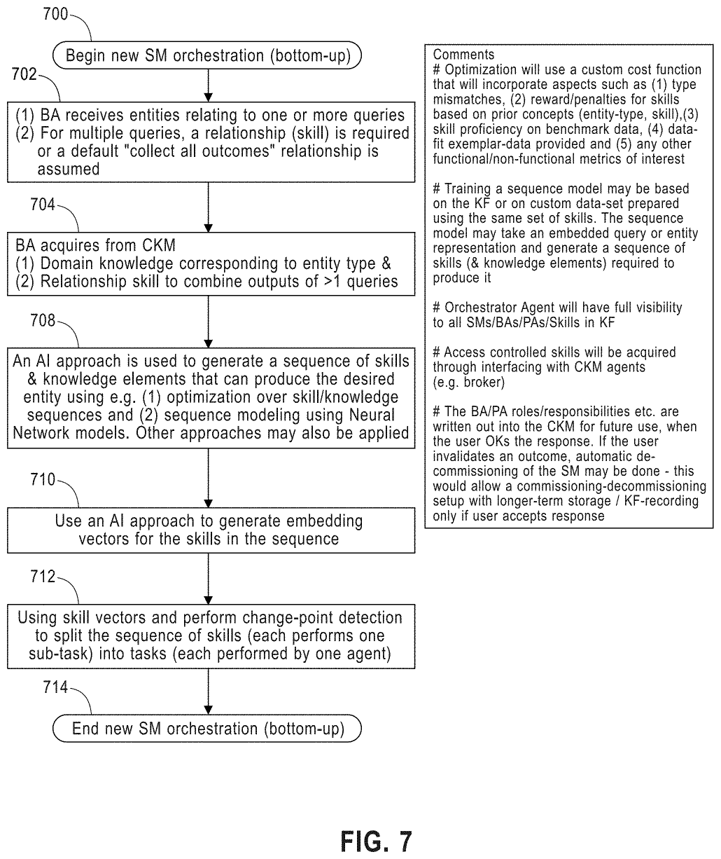

1. Executing a query using a machine identified by knowledge fabric 408b as described in the algorithm of FIG. 5, infra.
2. Executing multiple sub-queries via collaboration among agents 404a . . . 404n of a machine as described in the algorithm of FIG. 6, infra.
3. Generating a machine via orchestration of agents 404a . . . 404n and skills using bottom-up approach as described in the algorithm of FIG. 7, infra.
4. Generating a machine via orchestration of agents 404a . . . 404n and skills using top-down approach as described in the algorithm of FIG. 7, infra.

Subsequently, orchestrator agent 408c serves digital knowledge and skills 408a elements to the agent (via rest services). In response, the agent enables its task execution environment to execute a sequence of skills with respect to knowledge elements as prescribed orchestrator agent 408c. After execution of a task, the agent updates knowledge fabric 408b via execution of one or more of the following actions:

1. Any new knowledge created is transmitted back to KM 408 and incorporated into knowledge fabric 408b. Likewise, knowledge fabric 408b increases in size in response to digital tasks executed by agents 404a . . . 404n.
2. Reputation, quality, or importance scores may be added to the knowledge elements for enabling orchestration to select optimal sequences for execution.

FIG. 5 illustrates an algorithm detailing a process flow enabled by system 400 of FIG. 4 for executing a query using a machine identified by a knowledge fabric, in accordance with embodiments of the present invention. In step 502, a user query is received and in step 504 it is determined if the query is implicit or explicit. If in step 504, it is determined that the query is explicit then in step 506 a corresponding assistant is called and an output is generated for terminating interactions. If in step 504, it is determined that the query is implicit then in step 508 an orchestrator component extracts associated sub-queries. In step 510, a sub-query loop is initiated. In step 512, a knowledge framework is searched for concepts linking query entities. If a concept is located, then in step 518, a digital assistant determines if the concept should be refreshed and (in response) in step 520, the assistant refreshes the concept. Alternatively, if a concept is located, then in step 514 the knowledge framework generates entities oof interest and associated dependencies and in step 524 it is determined if a list of digital assistants has been located. If in step 524 it is determined that a list of digital assistants has not been located then in step 530, a new machine comprising digital assistants is generated. If in step 524 it is determined that a list of digital assistants has been located then in step 528, an existing machine comprising digital assistants is executed and in step 532 the process is terminated.

FIG. 6 illustrates an algorithm detailing a process flow enabled by system 400 of FIG. 4 for executing multiple sub-queries via collaboration among agents of a machine, in accordance with embodiments of the present invention. In step 602 the process is initiated. In step 604, a digital assistant receives entities associated with a query. In step 608, the digital assistant generates digital agents. In step 610, a query loop is initiated. In step 612, it is determined if an existing machine or new machine will be enabled. If in step 612, it is determined that an existing machine will be enabled then in step 614, digital agent dependencies are executed and in step 618, associated skills are executed thereby terminating the query loop. If in step 612, it is determined that a new machine will be enabled then in step 620, agents within the new machine are executed and the query loop is terminated.

In step 622, The digital assistant applies digital skills to query outputs and in step 624, the digital assistant returns query results to a user. In step 628, it is determined if an existing machine or new machine will be enabled. If in step 628, it is determined that an existing machine will be enabled then in step 632 the process is terminated. If in step 628, it is determined that a new machine will be enabled then in step 630, a user is queried for digital assistant names and in step 632 the process is terminated.

FIG. 7 illustrates an algorithm detailing a process flow enabled by system 400 of FIG. 4 for generating a machine via orchestration of agents and skills using bottom-up approach, in accordance with embodiments of the present invention. In step 700, a new machine orchestration (bottom up approach) is enabled. In step 702, a digital assistant receives entities associated with a query. In step 704, the digital assistant acquires domain information from a network (CKM) agent. In step 708, artificial intelligence (A/I) code is executed for generating a set of digital skills in a sequence. In step 710, the A/I code is executed for generating embedded vectors associated with the set of digital skills in the sequence. In step 712, the embedded vectors are executed for splitting the sequence of digital skills and the process is terminated in step 714.

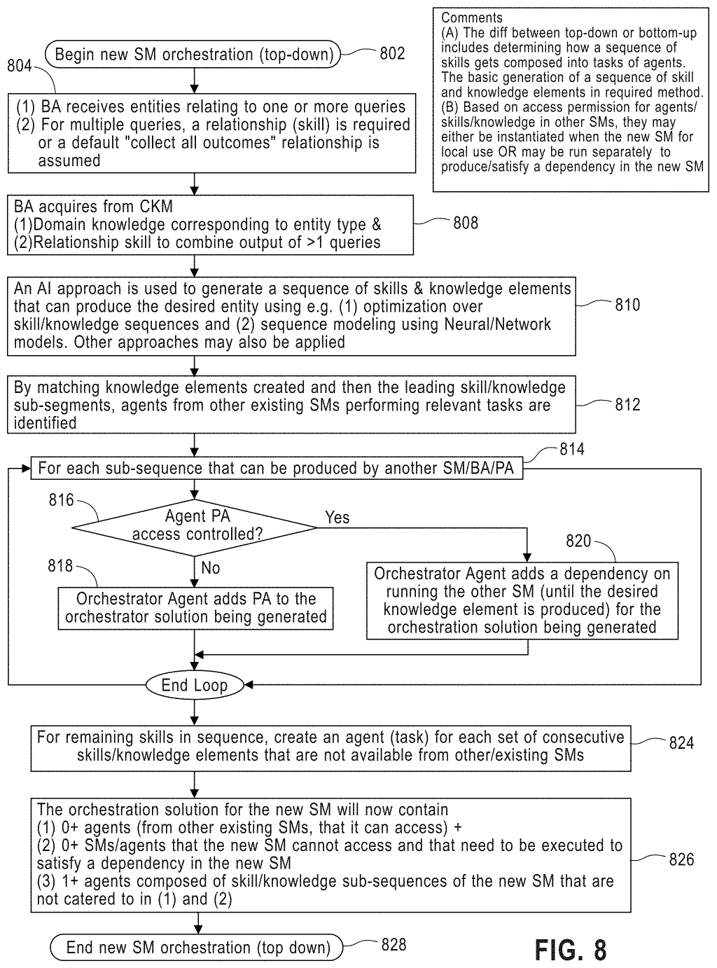

FIG. 8 illustrates an algorithm detailing a process flow enabled by system 400 of FIG. 4 for generating a machine via orchestration of agents and skills using top-down approach, in accordance with embodiments of the present invention. In step 800, a new machine orchestration (top up approach) is enabled. In step 804, a digital assistant receives entities associated with a query. In step 808, the digital assistant acquires domain information from a CKM agent. In step 810, artificial intelligence (A/I) code is executed for generating a set of digital skills in a sequence. In step 812, generated knowledge elements (associated with set of digital skills in a sequence) are matched. In step 814, a sequence loop is executed as follows:

In step 816, it is determined if digital agent access is controlled. If in step 816, it is determined that digital agent access is controlled then in step 820, an orchestrator agent adds a dependent agent running on another machine and the sequence loop is terminated. If in step 816, it is determined that digital agent access is not controlled then in step 820, an orchestrator agent adds a digital assistant to the digital agent and the sequence loop is terminated.

In step 824, remaining digital skills in the sequence are associated with additional generated digital agents. In step 826, the orchestrator agent for a new machine is associated with further digital agents and the process is terminated in step 828.

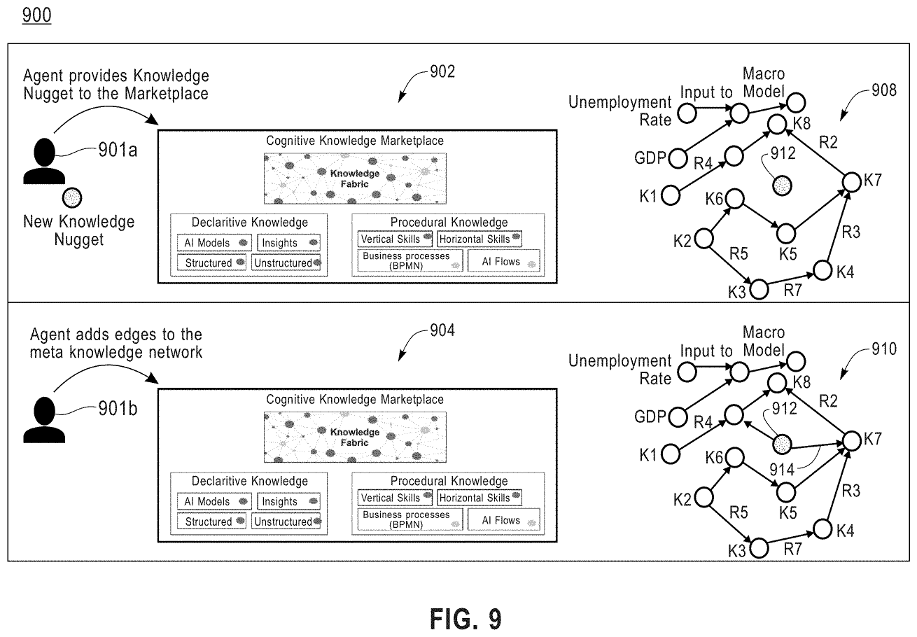

FIG. 9 illustrates a process 900 for enabling digital agents to collaboratively maintain a meta knowledge network, in accordance with embodiments of the present invention. The process is initiated when an agent 901a adds a digital knowledge element 912 to a marketplace 902 resulting in generation of a meta knowledge network 908 comprising a labeled property graph or RDF. Likewise, an agent 901b adds digital element edges 914 (to digital knowledge element 912) to marketplace 910 resulting in generation of a meta knowledge network 910 comprising a labeled property graph or RDF.

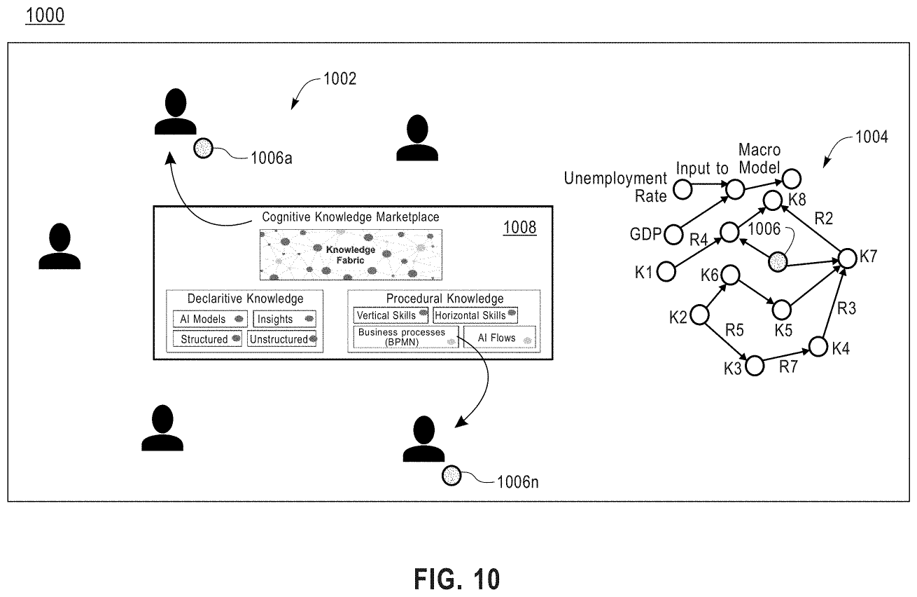

FIG. 10 illustrates an alternative process 1000 for enabling digital agents to collaboratively maintain a meta knowledge network, in accordance with embodiments of the present invention. The process is initiated when agents 1002 acquire digital knowledge elements 1006 (including elements 1006a . . . 1006n) for a marketplace 1008 resulting in generation of a meta knowledge network 1008.

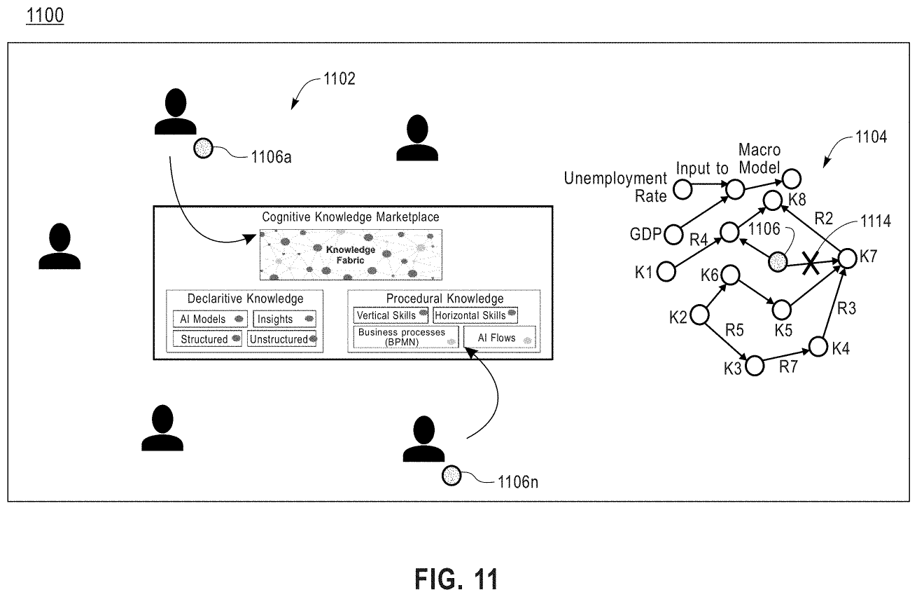

FIG. 11 illustrates an alternative process 1100 for enabling digital agents to collaboratively maintain a meta knowledge network, in accordance with embodiments of the present invention. The process is initiated when agents 1102 asynchronously upvote or downvote a relation based on what it observed with respect to digital knowledge elements 1106 (including elements 1106a . . . 1106n) for a marketplace 1108 resulting in generation of a meta knowledge network 1104. A relation (edge) 1114 is removed (from meta knowledge network 1104) based on downvotes from peer agents.

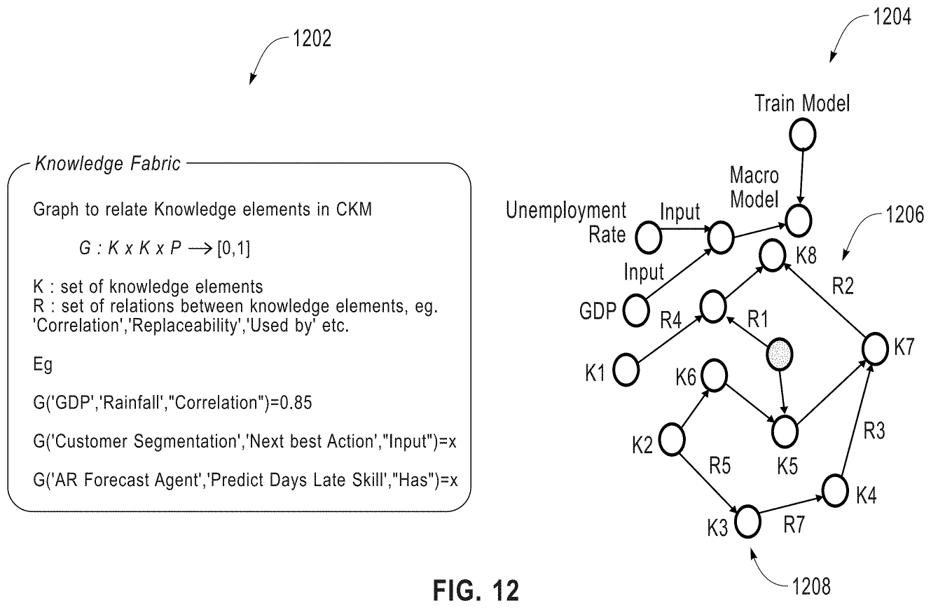

FIG. 12 illustrates a knowledge fabric 1202 comprising edges 1206 in a CKM 1204, in accordance with embodiments of the present invention. Nodes 1208 of the CKM 1204 comprise relationships for capture as a labeled property graph comprising a provision to capture a relation and a scalar for each directed edge (of edges 1206).

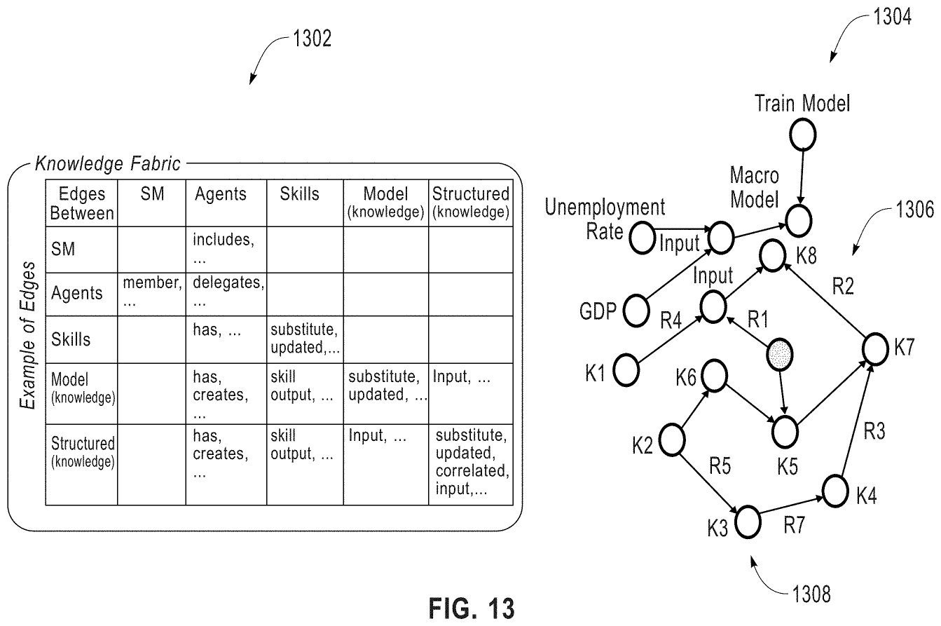

FIG. 13 illustrates an alternative knowledge fabric 1302 comprising edges 1306 in a CKM 1304, in accordance with embodiments of the present invention. Nodes 1308 of the CKM 1304 comprise relationships for capture as a labeled property graph comprising a provision to capture a relation and a scalar for each directed edge (of edges 1306).

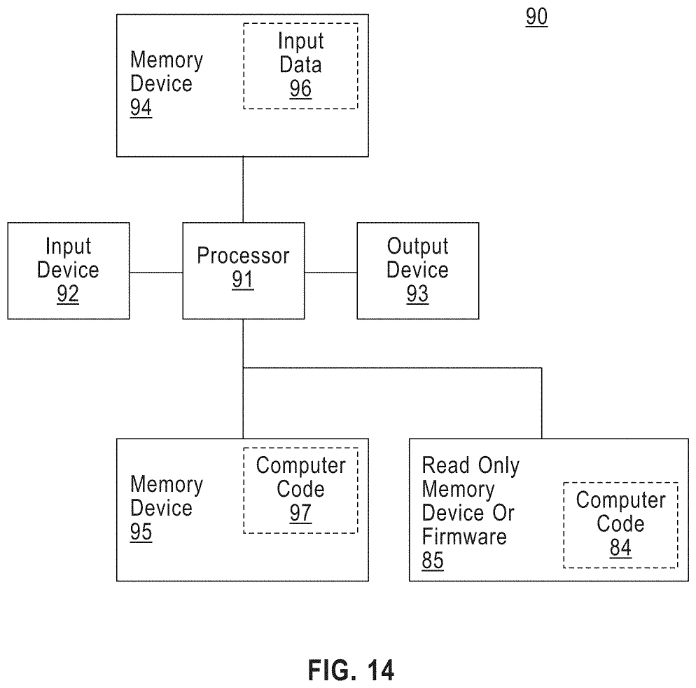

FIG. 14 illustrates a computer system 90 (e.g., hardware device 139, digital agents 140a . . . 140n, hardware interface 115, and knowledge fabric devices 112 of FIG. 1) used by or comprised by the system 100 of FIG. 1 for improving software technology associated with retrieving a query, selecting and executing associated digital skills, and enabling a hardware interface device to interact with devices for enabling operational functionality associated providing a set of knowledge, skills, and an associated sequence of operation, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 14 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithms of FIGS. 2 and 5-8) for improving software technology associated with retrieving a query, selecting and executing associated digital skills, and enabling a hardware interface device to interact with devices for enabling operational functionality associated providing a set of knowledge, skills, and an associated sequence of operation. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices Such as read only memory device 85) may include algorithms (e.g., the algorithm of FIGS. 2 and 5-8) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including algorithms) may be stored on a static, nonremovable, read-only storage medium such as a Read-Only Memory (ROM) device 85, or may be accessed by processor 91 directly from such a static, nonremovable, read-only medium. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with retrieving a query, selecting and executing associated digital skills, and enabling a hardware interface device to interact with devices for enabling operational functionality associated providing a set of knowledge, skills, and an associated sequence of operation. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with retrieving a query, selecting and executing associated digital skills, and enabling a hardware interface device to interact with devices for enabling operational functionality associated providing a set of knowledge, skills, and an associated sequence of operation. In another embodiment, the invention provides a business method that performs the process steps of the invention on a subscription, advertising, and/or fee basis. That is, a service supplier, such as a Solution Integrator, could offer to enable a process for improving software technology associated with retrieving a query, selecting and executing associated digital skills, and enabling a hardware interface device to interact with devices for enabling operational functionality associated providing a set of knowledge, skills, and an associated sequence of operation. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 14 shows the computer system 90 as a particular configuration of hardware and software, any configuration of hardware and software, as would be known to a person of ordinary skill in the art, may be utilized for the purposes stated supra in conjunction with the particular computer system 90 of FIG. 14. For example, the memory devices 94 and 95 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

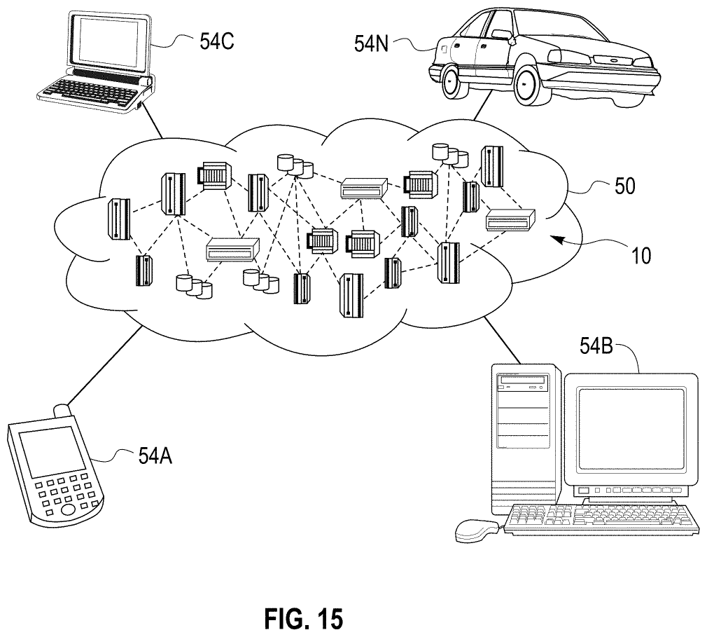

Referring now to FIG. 15, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 12 are intended to be illustrative only and that computing nodes 10 and cloud computing environment 50 can communicate with any type of computerized device over any type of network and/or network addressable connection (e.g., using a web browser).

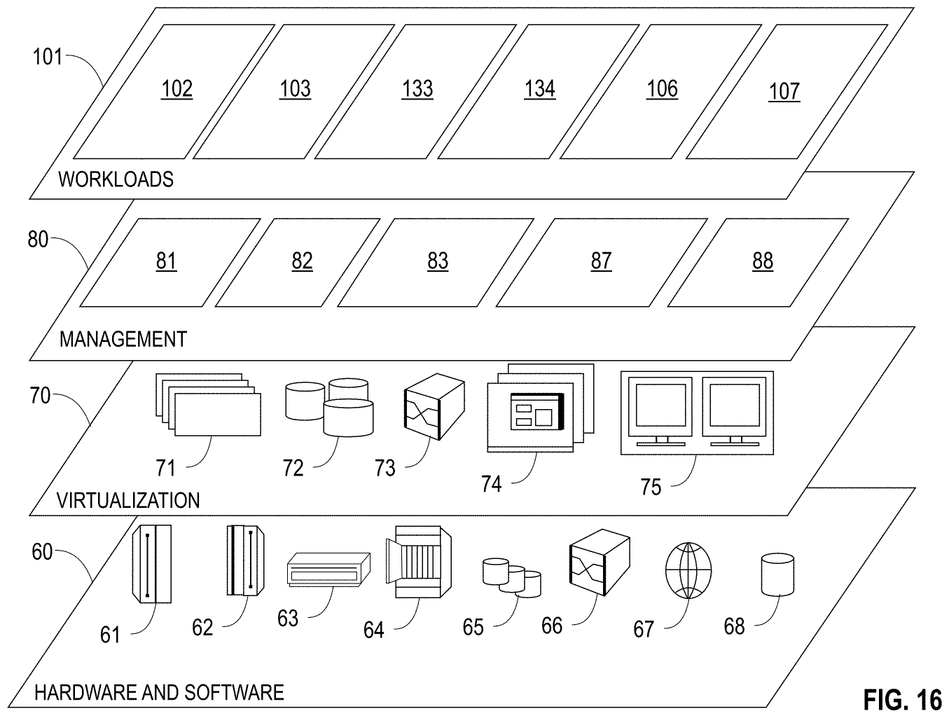

Referring now to FIG. 16, a set of functional abstraction layers provided by cloud computing environment 50 (see FIG. 15) is shown. It should be understood in advance that the components, layers, and functions shown in FIG. 16 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 87 provides cloud computing resource allocation and management such that required service levels are met. Service Level Agreement (SLA) planning and fulfillment 88 provide pre-arrangement for, and procurement of, cloud computing resources for which a future requirement is anticipated in accordance with an SLA.

Workloads layer 101 provides examples of functionality for which the cloud computing environment may be utilized. Examples of workloads and functions which may be provided from this layer include: mapping and navigation 102; software development and lifecycle management 103; virtual classroom education delivery 133; data analytics processing 134; transaction processing 106; and for improving software technology associated with retrieving a query, selecting and executing associated digital skills, and enabling a hardware interface device to interact with devices for enabling operational functionality associated providing a set of knowledge, skills, and an associated sequence of operation 107.

While embodiments of the present invention have been described herein for purposes of illustration, many modifications and changes will become apparent to those skilled in the art.

Accordingly, the appended claims are intended to encompass all such modifications and changes as fall within the true spirit and scope of this invention.

What is claimed is:

1. A hardware device comprising a processor coupled to a computer-readable memory unit, the memory unit comprising instructions that when executed by the processor implements an automated digital agent communication and control method comprising:
retrieving, by said processor from a first digital agent via a software/hardware interface, a query associated with knowledge based control process;
receiving, by said processor from said first digital agent, a set of digital knowledge elements, associated digital skills, and a sequence of control operations and associated code to obtain a response to said query;
selecting, by said processor based on said set of digital knowledge elements, said associated digital skills, and said sequence of control operations and associated code, a first possible set of knowledge of said set of digital knowledge elements, skills of said associated digital skills, and an associated sequence of operation of said sequence of control operations;
transmitting, by said processor to said first digital agent, said first possible set of knowledge, said skills, and said associated sequence of operation;
executing, by said processor via said first agent in response to said transmitting, a sequence of skills of said skills with respect to digital knowledge elements and components associated with said associated sequence of operation;
enabling, by said processor, a hardware interface device to interact with and control various devices for enabling operational functionality associated with devices for providing said first possible set of knowledge, said skills, and said associated sequence of operation; and
updating, by said processor via said first digital agent, knowledge based fabric code associated with future instances of said enabling said hardware interface device.

2. The hardware device of claim 1, wherein said software/hardware interface comprises an interface selected from the group consisting of a text interface, a voice activated interface, and an artificial intelligence (AI) interface.

3. The hardware device of claim 1, wherein said selecting comprises:
executing by said processor, an additional query associated with a social hardware and software machine with respect to said knowledge based control process, wherein said enabling is performed with respect to results of said additional query.

4. The hardware device of claim 1, wherein said selecting comprises:
executing, by said processor via a plurality of digital agents, multiple sub-queries associated with a social hardware and software machine with respect to said knowledge based control process, wherein said enabling is performed with respect to results of said multiple sub-queries.

5. The hardware device of claim 1, wherein said selecting comprises:
generating, by said processor via a plurality of digital agents, a social hardware and software machine via execution of bottom-up approach software code, wherein said enabling is performed in response to execution of said bottom-up approach software code.

6. The hardware device of claim 1, wherein said selecting comprises:
generating, by said processor via a plurality of digital agents, a social hardware and software machine via execution of top-down approach software code, wherein said enabling is performed in response to execution of said top-down approach software code.

7. The hardware device of claim 1, wherein said updating comprises:
adding, by said processor to said knowledge based fabric code, results of said query with respect to digital tasks executed by multiple digital agents.

8. The hardware device of claim 1, wherein said updating comprises:
adding, by said processor to said knowledge based fabric code, results of said query with respect to enabling orchestration code for selecting optimal sequence code.

9. An automated digital agent communication and control method comprising:
retrieving, by a processor of a hardware device from a first digital agent via a software/hardware interface, a query associated with knowledge based control process;
receiving, by said processor from said first digital agent, a set of digital knowledge elements, associated digital skills, and a sequence of control operations and associated code to obtain a response to said query;
selecting, by said processor based on said set of digital knowledge elements, said associated digital skills, and said sequence of control operations and associated code, a first possible set of knowledge of said set of digital knowledge elements, skills of said associated digital skills, and an associated sequence of operation of said sequence of control operations;
transmitting, by said processor to said first digital agent, said first possible set of knowledge, said skills, and said associated sequence of operation;
executing, by said processor via said first agent in response to said transmitting, a sequence of skills of said skills with respect to digital knowledge elements and components associated with said associated sequence of operation;
enabling, by said processor, a hardware interface device to interact with and control various devices for enabling operational functionality associated with devices for providing said first possible set of knowledge, said skills, and said associated sequence of operation; and
updating, by said processor via said first digital agent, knowledge based fabric code associated with future instances of said enabling said hardware interface device.

10. The method of claim 9, wherein said software/hardware interface comprises an interface selected from the group consisting of a text interface, a voice activated interface, and an artificial intelligence (AI) interface.

11. The method of claim 9, wherein said selecting comprises:
executing by said processor, an additional query associated with a social hardware and software machine with respect to said knowledge based control process, wherein said enabling is performed with respect to results of said additional query.

12. The method of claim 9, wherein said selecting comprises:
executing, by said processor via a plurality of digital agents, multiple sub-queries associated with a social hardware and software machine with respect to said knowledge based control process, wherein said enabling is performed with respect to results of said multiple sub-queries.

13. The method of claim 9, wherein said selecting comprises:
generating, by said processor via a plurality of digital agents, a social hardware and software machine via execution of bottom-up approach software code, wherein said enabling is performed in response to execution of said bottom-up approach software code.

14. The method of claim 8, wherein said selecting comprises:
generating, by said processor via a plurality of digital agents, a social hardware and software machine via execution of top-down approach software code, wherein said enabling is performed in response to execution of said top-down approach software code.

15. The method of claim 9, wherein said updating comprises:
adding, by said processor to said knowledge based fabric code, results of said query with respect to digital tasks executed by multiple digital agents.

16. The method of claim 9, wherein said updating comprises:
adding, by said processor to said knowledge based fabric code, results of said query with respect to enabling orchestration code for selecting optimal sequence code.

17. The method of claim 9, further comprising:
providing at least one support service for at least one of creating, integrating, hosting, maintaining, and deploying computer-readable code in the hardware device, said code being executed by the processor to implement: said retrieving, said receiving, said selecting, said transmitting, said executing, said enabling, and said updating.

18. A computer program product, comprising a computer readable hardware storage device storing a computer readable program code, said computer readable program code comprising an algorithm that when executed by a processor of a hardware device implements an automated digital agent communication and control method, said method comprising:
retrieving, by said processor from a first digital agent via a software/hardware interface, a query associated with knowledge based control process;
receiving, by said processor from said first digital agent, a set of digital knowledge elements, associated digital skills, and a sequence of control operations and associated code to obtain a response to said query;
selecting, by said processor based on said set of digital knowledge elements, said associated digital skills, and said sequence of control operations and associated code, a first possible set of knowledge of said set of digital knowledge elements, skills of said associated digital skills, and an associated sequence of operation of said sequence of control operations;
transmitting, by said processor to said first digital agent, said first possible set of knowledge, said skills, and said associated sequence of operation;
executing, by said processor via said first agent in response to said transmitting, a sequence of skills of said skills with respect to digital knowledge elements and components associated with said associated sequence of operation;
enabling, by said processor, a hardware interface device to interact with and control various devices for enabling operational functionality associated with devices for providing said first possible set of knowledge, said skills, and said associated sequence of operation; and
updating, by said processor via said first digital agent, knowledge based fabric code associated with future instances of said enabling said hardware interface device.

19. The computer program product of claim 18, wherein said software/hardware interface comprises an interface selected from the group consisting of a text interface, a voice activated interface, and an artificial intelligence (AI) interface.

20. The computer program product of claim 18, wherein said selecting comprises:
executing by said processor, an additional query associated with a social hardware and software machine with respect to said knowledge based control process, wherein said enabling is performed with respect to results of said additional query.
